(19) United States
(12) Patent Application Publication
(10) Pub. No.: US 2025/0138350 A1
(43) Pub. Date: May 1, 2025

(54) ACOUSTO OPTIC MODULATOR DEVICE FOR LIGHT FREQUENCY ADJUSTMENT

(71) Applicant: THE SECRETARY OF STATE FOR DEFENCE, Salisbury, Wiltshire (GB)

(72) Inventor: Matthew David Himsworth, Salisbury (GB)

(21) Appl. No.: 18/833,724

(22) PCT Filed: Jan. 18, 2023
(86) PCT No.: PCT/IB2023/050418

§ 371 Date: Jul. 26, 2024

(30) Foreign Application Priority Data
Jan. 28, 2022 (GB) 2201108.4

(51) Int. Cl. G02F 1/11

(52) U.S. Cl. CPC G02F 1/113

(57) ABSTRACT

An Acousto Optic Modulator Device has an Acousto Optic Modulator (AOM) 4 and an actuator controlled angle adjusting mirror, and means to pass light from an input port through the AOM to the adjustable angle mirror and back through the AOM to an output port. The effect of controlling the acoustic frequency in the AOM and the angle of the mirror is to selectively perform fine adjustments to the frequency of inlet laser light, permitting controlled or sudden changes.

The present invention relates to acousto optic modulators (known as AOMs) for adjusting a frequency of light from a light source, typically a laser. AOMs are used for laser beam modulation, frequency shifting and deflection, and are also known as Bragg cells, or acousto-optic deflectors.

AOMs typically comprise a crystal through which a RF frequency (in the MHz range) travelling pressure wave is passed, thus creating a periodic modulation of refractive index across the crystal. When a laser beam is aligned through the crystal at a nearly orthogonal angle to the RF wave, the periodic modulation acts like an optical grating causing the beams to be split into several deflection orders. Due to the traveling wave nature of the RF oscillation (at frequency F), each deflection order (m=±0, 1, 2, 3, . . . ) is shifted by mF. The amplitude of deflected beams depends on the RF power and switching times (between the RF is turned on an off), can be below a micro-second.

Typically this is achieved using a planar piezoelectric transducer arranged to convert the electrical/radio wave input into a pressure wave, and the medium or crystal used, is generally quartz. An acoustic absorbing material is positioned at the far side of the medium/crystal to absorb the pressure wave and prevent it reflecting back.

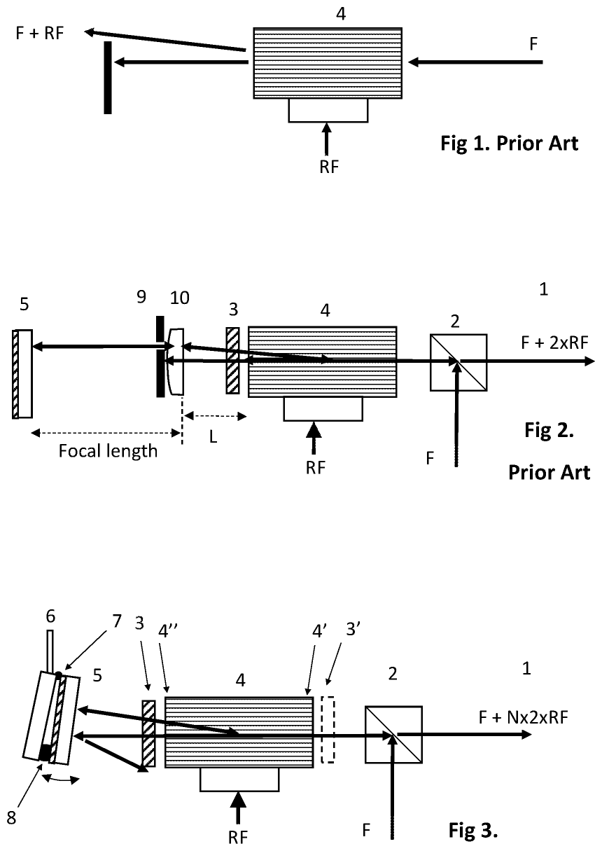

FIG. 1 shows a typical AOM, in which RF waves travel within a medium in which the refractive index of light is modified by the travelling wave, and which establishes a moving grating where the zero-order diffraction is at a predetermined angle. This can be used to select a single frequency from a mixture, or by selecting the first or later order diffraction, can be used to adjust the frequency of the light, albeit with a reduction in intensity.

All transparent materials have a photoelastic effect to some degree, however a material with a strong photoelastic coefficient is preferable, such as quartz (fused silica) or lithium niobate or others as are known in the field.

The deflection angle is proportional to the RF frequency. So if one wanted to change the frequency, then the beam direction changes slightly. This causes the beam to be misaligned further along the optical beam path. When laser are coupled into optical fibers, they require micron-level positioning accuracy. Therefore the ‘single-pass’ AOM configuration is only suitable for fixed frequency applications. It is possible to buy integrated single-pass AOM systems which are fiber coupled.

For some uses, it is necessary to change the frequency, sometimes frequently, and for this the ‘double-pass’ AOM system is used, in which the deflected beam is passed back into the AOM along the same incident path and can be extracted with polarizing optics (see FIG. 2). The symmetry of this system means that a change in the RF frequency no longer causes the beam angle to change. It also provides twice the frequency shift, which is usually advantageous.

The double pass method normally requires additional optical elements to ensure the beam is accurately reflected back along its incident path, which means that due to the size of the system it is difficult to integrate into a compact and rugged form, unlike the single-pass systems. Hence it is believed that there are no commercially available double pass AOM systems on the market in a compact form, which limits the portability of these systems.

FIG. 2 shows the double-pass method where a beamsplitter passes light into an AOM with one polarisation. This is used to select one frequency or to add a small adjustment to the frequency. The approach requires a lens a mirror, and an arrangement to block light paths corresponding to unwanted frequencies.

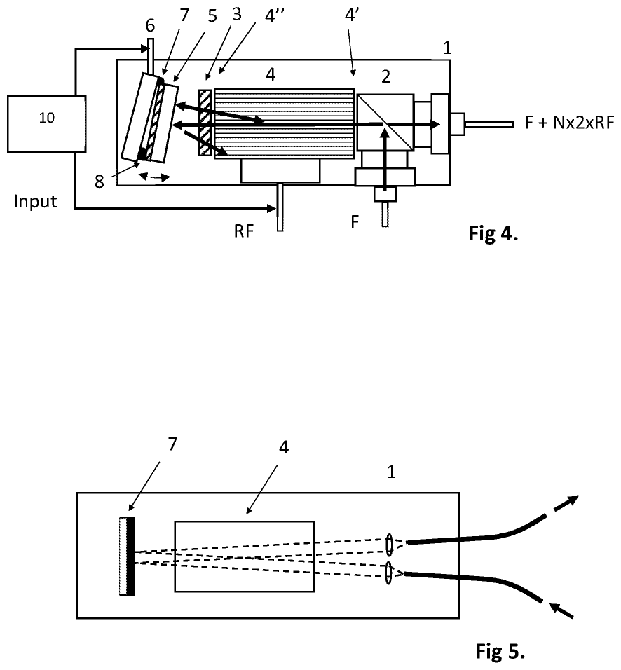

A quarter-wave plate is provided next to a polarising beam splitter, so that the light transmitted into the AOM is rotated (e.g. +45 degrees), reflected by the mirror reversing the polarisation 180 degrees, and then returned back through the quarter wave plate which rotates it another 45 degrees (e.g. positive 45 degrees rather than negative 45 degrees since the polarisation was reversed by the mirror), lending a final total of e.g. 270 degrees. This ensures that when the light arrives back at the polarising beam splitter it passes through to the outlet of the device (rather than returning the way it came in via the inlet). The quarter waveplate can alternatively be between the AOM and the mirror (as shown in FIGS. 3 and 4).

Typically the light blocking arrangement will be a black planar element with a slit (shown with the width of the slit exaggerated) which needs to be positioned manually on a lab bench. One advantage of the double-pass approach is that the increase in frequency is twice as great compared to passing the light through the AOM a single time. However the position of the slit often has to be manually aligned, and sometimes has to be done quite accurately. Typically it is difficult to select a new frequency adjustment quickly and reliably, and in particular difficult to provide a linear change in frequency over time (i.e. to chirp the laser frequency slowly), since adjusting the slit would simply cause the device to jump between different diffraction orders with an intervening loss in the optical signal.

Furthermore in the known double-pass arrangement the slit must not be excessively narrow. An excessively narrow slit causes diffraction and prevents the slit allowing an aligned beam through, and also makes it hard to align the mirror to ensure that the returned beam also passes through the same slit. As a result, this limits how selecting the slit can be, which in turn increases the distance that it must be positioned from the AOM, which increases the size of the overall AOM device. Accordingly these prior art double-pass arrangements tend to be bulky.

It is an object of the present invention to provide an improved AOM device in which rapid, continuously varying, and/or fine adjustments, can be performed more easily or reliably, and/or which can be more compact.

The beamsplitter is only one option for guiding the light in and out (optical isolator), and an alternative is to misalign the inlet slightly so that the reflected light will not arrive back at the inlet but rather at a different location where it can then be collected via the output, as shown in FIG. 5.

According to a first aspect of the invention, there is an AOM device as set out in claim 1.

According to a second aspect of the invention, there is an AOM device as set out in claim 2.

According to a third aspect of the invention, there is an AOM device as set out in claim 9.

According to a fourth aspect of the invention, there is provided the method of using an AOM device as set out in any one of the claims, to convert at least some of an inlet light beam with frequency F, to an output light beam with frequency F+(N×2×RF) where N is an integer and RF is the radio frequency applied to the AOM.

The quarter waveplate 3, 3′ can either be between the AOM and polarising beamsplitter, or can be between the AOM and the mirror (or in an extreme example might be incorporated within the AOM, e.g. as one of its ports, or on the surface of the mirror)—since its purpose is to ensure the light arrives back into the polarising beam splitter with the correct polarisation so as not to be redirected back out through the inlet path/i.e. towards the laser typically. Preferably it is between the AOM and the mirror 3, to avoid birefringence effects of the quarter waveplate affecting the performance of the AOM.

Any arrangement which achieves a 45 degree rotation in each direction of light travel is adequate, for example a quarter wave plate on one side of the AOM should be considered to cover equivalent approaches such as placing an 8^{th} waveplate in that location and another 8^{th} waveplate on the other side of the AOM, each providing a 45 degree rotation of the light in each direction. Similarly a quarter waveplate covers variants such as a waveplate offering 415 (45+360) degree rotation, and indeed 45+nx360 degrees (where n is a positive or negative integer) and also 135+nx360. Both 45 and 135 degree rotations will be effective, because by adding 135 degrees, reversing the polarisation and substracting 135 (in the opposite direction—i.e. thus adding), this arrives at a total of 270 degree rotation (which is also a 90 degree absolute rotation). Perfect precision in rotating the polarisation by 90 degrees is not essential, but the more deviation/inaccuracy there is the less efficient the polarising beam splitter (if used) will be, and for many applications high efficiency is not required. Preferably the total 90 degree rotation is achieved accurate to +/−1 degree. Accuracy to +/−10 degrees might be tolerated by some users and for the quarter waveplate to be useful it must be accurate to +/−40 degrees.

Similarly it is generally necessary that the mirror is of the conventional type that reverses the polarisation of the light, as typical mirrors do. Some specialised mirrors have been reported in the literature which do not reverse the polarisation, and these should not be used unless measures are taken to ensure that the frequency adjusted light does not wholly pass back out through the inlet of the AOM device but rather the frequency light (or at least some of it) passes out of a separate outlet.

FIG. 3 shows an illustration of an embodiment of the invention. Whilst a blocking arrangement with a slit may still be used, it is typically far wider than in the prior art double pass arrangement and does not need to be adjusted. In some embodiments it may be omitted.

Similarly the lens is typically obviated in most embodiments, although there could be reasons to retain some form of lens for some purpose. If a non-flat mirror is chosen for some reason this may necessitate a lens. If the mirror is concave this might not require a lens between the mirror and the AOM although adding a lens on the other side of the AOM might then be necessary to address focusing caused by the concave mirror.

Instead the control of the device is achieved by simultaneous automated adjustment of the AOM acoustic frequency, as well as automated fine adjustment of the angle of the mirror. This approach poses a significant challenge, in that to avoid the device skipping between diffraction orders and to enable a gradual change to the output light frequency, both the mirror and the AOM acoustic frequency need to be finely controlled precisely in tandem. This is much more difficult to achieve compared to simply sliding a single piece of black paper/material with a slit laterally along a guide. The angular adjustments to the mirror required will typically be very small precise changes, which is made possible by an actuator, such as a piezoelectric actuator, as opposed to the traditional approach of adjusting optical elements on a laboratory bench which was by manual adjustment of a screwthread. In a simple embodiment the mirror has an actuator at/near one side, and a pivot some distance away from it, such as at the other side, enabling fine adjustments to the angle of the mirror. Maximising the distance between the actuator and the pivot maximises how finely the mirror angle can be controlled.

FIG. 4 shows another embodiment of the invention, this time illustrating how compact the arrangement can be. The mirror is arranged much closer to the AOM than in the prior art, enabling the AOM device to be more compact. In this embodiment no blocking element with a slit is provided, and the only limitation on light returning into the AOM is the size of the AOM outlet aperture and/or the size of the mirror.

The angle of the mirror, and the frequency of the AOM are jointly selected such that light leaving the AOM with a frequency offset/change 50% of that required, will leave the AOM orthogonal to the mirror, thus returning into the AOM at the same angle it left, and as a result will then be frequency adjusted a second time by the AOM and light having 100% of the desired frequency offset will then be directed parallel to the light arriving from the beam splitter, and will enter the beam splitter so as to pass to the outlet of the AOM device.

Thus by correct selection of both the mirror angle and the AOM acoustic frequency, a desired frequency adjustment can be made, and this adjustment can be finely controlled and the output light frequency could be for example be ramped up or down gradually over time if desired.

Larger frequency adjustments are also possible, as was also the case with the prior art two-pass approach, by utilising different diffraction orders from the AOM. For example if a small frequency adjustment is desired, the 0 order or 1^{st} order diffraction can be utilised. If a large frequency adjustment is desired, the 2^{nd} 3^{rd} or higher order diffraction can be selected. A gradually varying frequency adjustment is possible whilst using a consistent diffraction order, but there would be a jump or break in the light beam when changing from using one diffraction order to another. Compared to the prior art approach such jumps or breaks can typically/potentially be much faster/briefer, since in typical embodiments the mirror can be automatically adjusted to the precise angle required, far faster than a human could manually reposition the slitted light blocker to the precise position required (e.g. 5 milliseconds rather than 5 seconds, depending on the actuator used).

Compared to the prior art arrangement in FIG. 3, the passive optical elements used to reflect the beam back through the AOM are replaced by an actively aligned mirror. The beam exiting the AOM after its first path is reflected back by a single mirror which is attached to an electro-mechanical actuator. This could be a piezo tilt stage, an electromagnetic actuator, a piezo bender, or a mems mirrors, or the adjustable mirror could be an angle-adjustable liquid crystal deflector.

Any actuator can be used, preferably one that can provide sub-milliradian (e.g. 0.01 to 0.9 milliradian) pointing accuracy of the beam. The actuator preferably has a range of tens of milli-radians (E.g. 20 to 90 milliradians). The actuator preferably has a short settling time when switching between positions (e.g. 0.01 to 10 ms).

As an example, an 80 MHz AOM, may require an angle shift of 4 milliradians (half the beam deflection angle); the angle change is linearly proportional to the frequency shift. If the mirror is fixed, any frequency shift in the AOM drive RF will cause the system to become misaligned. By adjusting the mirror angle alongside the RF frequency, the retro-reflection can remain optimised. Moreover, it is possible to swap the reflection between different diffraction orders of the AOM, thus allowing frequency jumps between zero shift (0^{th} order), twice the drive RF frequency, or even four times the drive frequencies (with a reduction of coupling power with higher orders) or higher. This ‘tilt-shift’ AOM configuration can therefore act like a simple optical switch, or a dynamic frequency shifter.

Preferably the AOM device is mounted on a single rigid base, to reduce beam path lengths, thermal drifts and beam expansion, to form a (compact) integrated system. A MEMs micro-mirror (such as the Hamamatsu S12237-03P) is an example of an actuated mirror which could be used.

For completeness, the mirror could be actuated to pivot via more than one hinge or more generally in more than one axis, such that the x & y angle of the beams can be controlled to couple into the fiber or other optical output path. Rather than a polarization splitting cube, a polarising splitting fiber could be using.

For completeness, by ‘an orientation of the mirror arranged such that the outlet light path is displaced with respect to the inlet light path’, this means a translation in an axis perpendicular to an axis in which the returned light varies according to frequency. Generally this entails a predetermined light inlet location and predetermined light outlet location (either in-use, or defined by respective inlet/outlet optical ports) with the mirror arranged to direct light of at least one frequency from the inlet to the outlet, such that the inlet and outlet are physically separated. In an extreme case however, it can be left to the user to direct light in from one direction, and receive light at the direction reflected by the mirror With reference to FIG. 5 the outlet path is translated up/down the page as shown, whereas different frequencies of light would be received at different distances in/out of the page. All of these embodiments involve apparatus where the light directed in through the AOM is splits into an array of beams of differing frequencies, the array being in a plane which is non-orthogonal to the mirror, and on reflection of the mirror the is directed light back through the AOM and is again split into a second array of beams of differing frequencies, this second array being in a second plane, with the key point being that the two planes of arrays of beams are non orthogonal. To achieve this, either the AOM device either has optical ports arranged for input and output of light in the aforementioned arrangement, or has an inlet and outlet (or a combined inlet/outlet) arranged to allow a user to direct light in in such a direction (i.e. an off axis direction) and receive light out at the corresponding outlet direction.

Further embodiments are set out in the claims.

A preferred embodiment of the invention will now be described, by way of example only, and with reference to the accompanying figures in which:

FIG. 1 is a diagram of a known type of acousto optic modulator (AOM);

FIG. 2 is a diagram of a known type of double-pass approach using an AOM to adjust or filter a frequency of light;

FIG. 3 is a diagram of an AOM device according to an embodiment of the invention;

FIG. 4 is a diagram of an AOM device according to another embodiment of the invention;

FIG. 5 is a diagram of an AOM device shown from above rather than the side, illustrating how slight misalignment of the input beam enables light to enter and leave via different ports of the AOM device.

Turning to FIG. 1, an AOM 4 is shown. This is a chamber with optical ports at either end and filled with a medium where the refractive index of light passing through it varies according to the pressure of the medium. A transducer at one side of the AOM converts a radio frequency signal (RF) into pressure waves, so that the pressure waves cross the AOM. This sets up a moving array of locations where the refractive index is raised (or lowered), which presents a moving diffraction grating to the incoming light or laser at its initial frequency F. The light is influenced by the moving diffraction grating so as to exit at a different angle, and at an increased frequency F+RF. Additional diffraction orders will exit at different angles, with even higher frequencies. Usually the RF frequency will be a tiny fraction of the frequency of the light, and so F+RF will be very slightly higher frequency than F.

FIG. 2 shows how such an AOM can be arranged to operate in double-pass arrangement, as is known in the art. A polarising beam splitter 2 passes polarised light from an input at frequency F, via a quarter wave plate 3 which rotates it's polarisation by 45 degrees. Light blocking element 9, which may be for example a piece of black paper or other planar material, has a slit arranged to permit light through, exiting at a predetermined angle from the AOM. A lens 10 which can be either side of the light blocking element 9, focusses the light to a stationary mirror 5, which returns the light through the same slit and lens, back to the AOM. Because the light arrives at the same angle it left, it is influenced by the moving diffraction grating to increase its frequency further, before exiting through the quarter wave plate 3 and polarising beam splitter 2.

As a result of passing through the quarter wave plate, having its polarisation reversed by the mirror, and passing a second time through the quarter wave plate, it's polarisation is at 90 degrees to the incoming light, and thus it passes through the polarising beam splitter to exit at frequency F+N×2×RF, where N is the diffraction order and F is the optical frequency. The RF frequency must be selected such that the desired output frequency is achieved, and the slit must then be positioned, taking into account the RF frequency, so as to select the desired diffraction order. This is difficult to do both quickly and precisely. In addition, the required lens introduces a necessary gap (focal length), which adds to the overall size of the AOM device 1. Similarly, since the slit cannot be so narrow as to cause undue diffraction of its own, and also cannot be so narrow that any misalignment of the mirror will cause the returned light to miss the slit, this means that the slit (or the lens if inboard of the slit) must be positioned some minimum distance (L) from the AOM in order to be adequately selective and not to allow the wrong frequencies of light through. Again this adds to the overall size of the AOM device 1.

FIG. 3 shows an AOM device 1 according to an embodiment of the invention. The polarising beam splitter 2, quarter wave plate 3, and the AOM itself 4 are the same as in the prior art shown in FIG. 2, however instead of a lens and blocking element with a slit, an angle-adjustable mirror 5 is positioned at the outlet of the AOM 4. This has a pivot 7 (generally a hinge) and an actuator 8 which may be an electric or electromagnetic actuator such as a motorised actuator, shape memory actuator or preferably a piezo-electric actuator. By arranging the pivot 7 at one side, and the actuator at opposite sides of the mirror, greater granularity and fine control is achievable.

The user controls the RF frequency into the AOM 4, and also the mirror angle, simultaneously, for example using any type of control circuitry 10, e.g. a computer, such as a laptop or Arduino (RTM). This may be provided separately from the AOM device 1, or may be provided integrally within the AOM device 1 (not shown). The controller takes one or more input(s) and configures the RF frequency and the mirror angle to achieve a desired output. The input(s) to the controller may for example be the input light frequency F and a desired output light frequency. This may in turn be received from other equipment or computer devices, as part of a larger optical system, or alternatively the input may be received using a user interface (not shown) such as dials or buttons.

Of course there are alternative ways to adjust a direction that a mirror reflects which are also covered, for example providing it with a transparent liquid cell in front of its reflective surface, and adjusting the angle of one of the walls of the liquid cell. Similarly it is not strictly necessary for the mirror to be flat, although in most cases another correcting optical element would be required to compensate for it not being flat. 3D retroreflectors should not be used as a substitute for a mirror as this would render the tilting of the mirror redundant, however a lenticular array of 2D retroreflectors could be arranged to have the desired effect provided that the array was oriented so that as the angle of the array was adjusted, it would selectively return light to the AOM parallel to its exit angle, based on the angle that the light had exited the AOM.

In FIGS. 3 (and 4) the input light into the AOM is illustrated as being parallel to the pressure waves, however the input light may advantageously be oriented a small angle (typically a few degrees) out of alignment, so that the input light direction has a small component in the opposite direction of the acoustic wave travel direction. This arrangement is known in the art and can be used to provide enhanced transmission efficiency especially when using the zero order diffraction.

FIG. 4 illustrates how the approach in FIG. 3 can be used to make a more compact AOM device, since the mirror can be brought much closer, indeed potentially substantially adjacent to, the second port 4″ of the AOM (obviously with enough clearance to allow the mirror to be adjusted). Features have the same labels as in FIG. 3.

In FIG. 4, the key components are shown in a housing 11, and provide a potentially structurally resilient and compact solution. By contrast the prior art solution in figure was typically implemented on a lab bench as separate manually positioned components.

Controller 10 is shown outside the housing 11 but could optionally be provided with the other components, or integrally within the housing 11. Where the use has a computer suited to controlling an optical apparatus, the user could connect this to control the mirror and the RF input simultaneously, so either the AOM device should include a dedicated controller, or the AOM device should be arranged for its mirror and RF input to be simultaneously controlled by the user's own computer equipment.

Turning to FIG. 5, another embodiment of the AOM device of the present invention is illustrated, as compared to FIG. 4, FIG. 5 shows a top view of the AOM rather than a side view, and therefore the angle of the mirror and the deflection caused by the AOM are not shown. Input and output ports (e.g. fibre cables) are shown on the right, and these are offset with respect to the mirror, such that light entering via one point is returned to a different port. This provides an alternative form of optical isolator, as compared to using a beamsplitter. It may reduce the performance of the device compared to using a polarising beam splitter and quarter waveplate, however it is a cheaper solution.

More generally there is provided an Acousto Optic Modulator Device that has an Acousto Optic Modulator (AOM) 4 and an actuator controlled angle adjusting mirror, and means to pass light from an input port through the AOM to the adjustable angle mirror and back through the AOM to an output port. The effect of controlling the acoustic frequency in the AOM and the angle of the mirror is to selectively perform fine adjustments to the frequency of inlet laser light, permitting controlled or sudden changes.

According to one aspect there is provided an Acousto Optic Modulator Device 1 comprising: an Acousto Optic Modulator (hereafter referred to as an AOM) providing an optical path therethrough, having a first optical port 4′ arranged at a first end thereof, and a second optical port 4″ at a second end thereof, —wherein the AOM comprises a transparent medium arranged to transmit light between the first and second optical ports 4′ 4″, having a refractive index of light that varies in response to the pressure of the medium, and comprising a pressure transducer arranged to receive a radio frequency RF and to generate acoustic waves crossing the transparent medium; —a mirror 5 arranged at the second end of the AOM arranged to reflect light from the second optical port 4″ of the AOM back into the second optical port 4″ of the AOM; and—light distinguishing means comprising either: an orientation of the mirror arranged such that the outlet light path is displaced with respect to the inlet light path, or a quarter wave plate arranged outboard of one end of the AOM, such that the polarisation of inlet light having a dominant polarisation direction, is perpendicular to that of outlet light; and Characterised in that the Acousto Optic Modulator Device 1 further comprises: a controllable actuator 8 arranged to adjust the orientation of the mirror 5; and a controller 10, arranged to simultaneously adjust both the radio frequency into the pressure transducer to control a frequency of acoustic waves crossing the transparent medium, and the controllable actuator 8 to control the orientation of the mirror.

1. An Acousto Optic Modulator Device comprising:
an Acousto Optic Modulator (hereafter referred to as an AOM) providing an optical path therethrough, having a first optical port arranged at a first end thereof, and a second optical port at a second end thereof;
wherein the AOM comprises a transparent medium arranged to transmit light between the first and second optical ports, along a first axis, having a refractive index of light that varies in response to the pressure of the medium, and comprising a pressure transducer arranged to receive a radio frequency RF and to generate acoustic waves crossing the transparent medium substantially along a second axis;
a mirror arranged at the second end of the AOM arranged to reflect light from the second optical port of the AOM back into the second optical port of the AOM; and
light distinguishing means arranged to reduce or prevent light from exiting the Acousto Optic Modulator Device without first passing through the AOM, comprising either:
an orientation of the mirror arranged such that the outlet light path is displaced relative to the inlet light path with respect to a third axis that is perpendicular to the first and second axes, and/or
a quarter wave plate arranged outboard of one end of the AOM, such that the polarisation of inlet light having a dominant polarisation direction, is perpendicular to that of outlet light; and
Characterised in that the Acousto Optic Modulator Device further comprises:
A controllable actuator arranged to adjust the orientation of the mirror such that the path of reflected light is displaced with respect to the second axis; and
A controller, arranged to simultaneously adjust both the radio frequency into the pressure transducer to control a frequency of acoustic waves crossing the transparent medium, and the controllable actuator to control the orientation of the mirror.

2. Acousto Optic Modulator Device according to claim 1, wherein:
The light distinguishing means comprises a quarter wave plate arranged outboard of one end of the AOM, such that the polarisation of inlet light having a dominant polarisation direction, is perpendicular to that of outlet light; and
The Acousto Optic Modulator Device comprises an optical isolator having an inlet and an outlet, arranged to direct light from the inlet into the first end of the AOM, such that at least some of the light returned via the mirror back out of the first end of the AOM is directed to the outlet.

3. Acousto Optic Modulator Device according to claim 2, wherein the optical isolator comprises a beam splitter arranged to accept light from the inlet, and to direct at least a portion of light returning from the mirror via the AOM, to the outlet.

4. Acousto Optic Modulator Device according to claim 3, wherein the beam splitter is a polarising beam splitter arranged to direct light to the AOM with an initial polarisation, and the optical isolator further comprises a quarter waveplate arranged to rotate the polarisation of light passing between the beam splitter and the mirror, such that light from the polarising beam splitter is rotated by the quarter waveplate, reflected by the mirror and rotated a second time by the quarter waveplate such as to arrive at the polarising beam splitter with substantially orthogonal polarisation to its initial polarisation, such that the polarising beam splitter passes it to the outlet.

5. Acousto Optic Modulator Device according to claim 4, wherein the quarter waveplate is arranged between the second end of the AOM and the mirror.

6. Acousto Optic Modulator Device according to claim 1, wherein the mirror comprises a hinge arranged at one portion of the mirror, and the controllable actuator is arranged at a distal portion of the mirror compared to the hinge, so as to rotate the mirror with respect to the hinge.

7. Acousto Optic Modulator Device according to claim 1, wherein the mirror is arranged no more than twice as far from the second port of the Acousto Optic Modulator as the first port is.

8. Acousto Optic Modulator Device according to claim 7, wherein the mirror is arranged substantially adjacent to the second port of the Acousto Optic Modulator.

9. Acousto Optic Modulator Device according to claim 1, wherein the controller is provided with data on a working frequency range of the Acousto Optic Modulator, and a working light transmission angle range of the second port of the Acousto Optic Modulator or adjustment angle range of the mirror, and is adapted to:
accept as an input an input light frequency;
accept as an input a desired output light frequency;
determine a lowest possible diffraction order within the transparent medium where, within the constraints of the working frequency and angle ranges, the input light frequency can be converted to the desired light frequency;
determine a required mirror orientation/adjustment and RF frequency required to convert the input light frequency into the desired light frequency at the identified lowest possible diffraction order; and
simultaneously control the controllable actuator to control the mirror orientation/adjustment, and the input RF frequency, such that the Acousto Optic Modulator converts at least some of any input light at frequency into output light at the desired frequency.

10. Acousto Optic Modulator Device according to claim 9, wherein the controller is adapted to accept as an input a plurality of input light frequencies, and to selectively control a light source to generate one of those light frequencies that the Acousto Optic Modulator Device is capable of converting into the desired light frequency.
